(19) United States
(12) Patent Application Publication
(10) Pub. No.: US 2026/0285281 A1
(43) Pub. Date: Sep. 24, 2026

(54) ACTUATOR, IN PARTICULAR FOR A CLAMPING MODULE OF AN ELECTROMECHANICAL BRAKE DEVICE FOR A MOTOR VEHICLE

(71) Applicant: AUMOVIO Germany GmbH, Frankfurt am Main (DE)

(72) Inventors: I-Che Chiang Chiang, Frankfurt am Main (DE); Mathias Haag, Darmstadt (DE); Sven Rückert, Reinheim (DE); Marco Besier, Bad Schwalbac (DE); Beatrice Pfalzgraf, Darmstadt (DE)

(73) Assignee: AUMOVIO Germany GmbH, Frankfurt am Main (DE)

(21) Appl. No.: 19/570,584

(22) Filed: Mar. 18, 2026

(30) Foreign Application Priority Data
Mar. 18, 2025 (DE) 10 2025 110 346.1

(51) Int. Cl. B60T 13/74; F16D 55/226; F16D 65/18; F16D 121/18; F16D 125/40

(52) U.S. Cl. CPC B60T 13/746; F16D 55/226; F16D 65/18; F16D 2121/18; F16D 2125/40

(57) ABSTRACT

A clamping module can be used to move a brake piston in the electromechanically actuatable wheel brake. An actuator for the clamping module of an electromechanical brake device for a motor vehicle comprises a ball screw drive having a spindle and a nut, wherein arranged between the spindle and the nut is at least one helically encircling groove track which is filled with a plurality of balls. Here, deflections are provided which allow a transfer of balls of one section of the groove track to an adjacent section of the groove track.

### TECHNICAL FIELD

The embodiments relate in general to an actuator for a clamping module of an electromechanical brake device for a motor vehicle. The clamping module can be used to move a brake piston in the electromechanically actuatable wheel brake.

### BACKGROUND

In modern motor vehicles, electromechanical wheel brakes (“EMB”) are currently developed and increasingly used as service brakes. These wheel brakes offer several differences from conventional, hydraulically actuated wheel brakes. They eliminate the need for a complex hydraulic system, and an electromechanical wheel brake is also significantly more space-saving.

Such electromechanically actuatable wheel brakes typically have a drive unit which interacts with a mechanism or a transmission. A brake unit may then be arranged on the output side, which brake unit may comprise, for example, a brake part, for instance a brake piston, and a friction pad. During operation, the brake part can then be pressed against a rotating brake disk or brake drum by means of a translational movement via the friction pad for braking. As a result, deceleration can be effected during operation. The drive unit typically comprises at least one electric motor. Various types of actuators are known for converting the rotational movement of the electric motor into the required translational or linear movement, which can be based on different mechanisms. One known mechanism is for example a ball screw drive (“KGT”). The ball screw drive offers the possibility of a linear force transmission.

However, known electromechanical brake devices with a ball screw drive as rotation/translation converters are of relatively long construction in order for instance to be able to bridge comparatively long distances, also with a view to compensating wear of brake pads. However, if a clamping module is to be used as a service brake, for example, for an electromechanically actuatable disk brake, then a greater extension in the axial direction is unfavorable, in particular if this is to be integrated on the front axles of a motor vehicle. Specifically at the front axles, the steering angle requires as small an axial installation length as possible, i.e. an only small extent in the direction of the piston axis, in order to be able to integrate electromechanically actuatable wheel brakes into modern passenger car front axle installation spaces. The axial structural length of electromechanically actuatable wheel brakes is therefore of importance.

A further aspect in the case of electromechanically actuatable brake devices which have actuators with a ball screw drive is that a plurality of balls are provided in the ball screw drive, said balls typically running in correspondingly prepared groove tracks and are able to transmit a force between the spindle and the nut during operation. In order to permit a movement of the balls during operation, a ball return is often provided.

One possibility is to provide a ball return from the inlet of the groove track to the outlet of the groove track in the nut. This can, however, be costly to produce. It can also lead to a larger diameter of the nut being required, which can lead to an overall larger ball screw drive or actuator.

Accordingly an actuator, for example for a clamping module of an electromechanically actuatable wheel brake, which mitigates or does not have the difficulties mentioned above. In this case, the actuator should be able to interact with a ball screw drive or be able to comprise a ball screw drive. In this case, it should be possible to use an electromechanically actuatable wheel brake with such an actuator as a service brake. It is furthermore sought to reduce the axial structural length of the clamping module to as short as possible.

### SUMMARY

This objective is achieved by an actuator, for example, for a clamping module of an electromechanical brake device for a motor vehicle, a clamping module having an actuator of said type, and an electromechanical brake device. Accordingly, a first aspect relates to an actuator, for example, for a clamping module of an electromechanical brake device for a motor vehicle. An actuator may comprise a ball screw drive having a spindle and a nut, wherein arranged between the spindle and the nut is at least one helically encircling groove track which is filled with a plurality of balls, wherein at least one deflection is provided which permits a transfer of balls of one section of the groove track to an adjacent section of the groove track, in the case of a rotation of the spindle about a spindle axis, wherein the at least one deflection is arranged along a first circular arc in relation to a circular line of a circle which results from a section through the ball screw drive perpendicular to the spindle axis, and wherein no deflection is arranged in particular on a second circular arc arranged opposite the first circular arc.

The embodiments allow better force absorption and force distribution during operation of the actuator, for example, when it is used for a clamping module of an electromechanical brake device for a motor vehicle.

A ball screw drive is assumed to be fundamentally known to a person skilled in the art, and will therefore be briefly outlined at this point only in relation to the essential aspects of the present embodiments. In the case of an actuator with a ball screw drive, in a correspondingly designed clamping module, the application of the clamping force can be performed by means of the nut and the spindle, which thus interact as a rotation-translation converter. Based on a drive torque of an electric motor, which can preferably be transmitted to the spindle via correspondingly designed gear units, a pressure piece, for example a piston of a clamping module, can be displaced in an axial movement relative to a surrounding housing by means of the nut. In this way, it is possible, for instance in the case of an electromechanical disk brake, for friction pads to be moved against a rotating element, e.g. a brake disk, and pressed in order to generate a predetermined braking torque depending on the clamping force.

In the case of a ball screw drive, at least one helically encircling groove track is provided. Typically, two helically encircling groove tracks are provided, which are respectively assigned to the nut and the spindle and correspond to one another. A plurality of balls can run in the helical tube formed in this way. In the case of a rotational movement between the spindle and the nut, the balls in said tube can move in accordance with the direction of rotation. In the case of a ball screw drive which is provided for an actuator in a clamping module of an electromechanical brake device, it may provide groove tracks or tubes which are guided around the spindle multiple times and which thus extend over more than 360°, for example, also over a multiple of 360°. Here, the nut and the spindle may each comprise a continuous groove track. It is however also possible, as provided in one embodiment of the invention, for only one continuous groove track to be provided on the spindle, and for a plurality of mutually separated groove tracks to be provided in the nut, wherein the groove tracks may be separated from one another by deflections. In this way, an axial force which arises during the application of the wheel brake can be readily absorbed and transmitted to a surrounding housing or a housing which accommodates the actuator.

In presently known solutions, ball return within the wall of the nut from an inlet of the groove track to an outlet of the groove track can be provided for said groove track or tube. This can lead to long spherical chains in the region of the deflection, which in turn can lead to increased friction. As a result, the balls may no longer automatically travel in one direction.

The embodiments therefore provides deflections in which smaller ball chains are formed, that is to say, only a few balls run in the region of the deflection, for example only 5 balls per deflection or fewer than 5 balls, fewer than 4 balls, or even fewer than 3 balls in a deflection. This results in less resistance due to friction, i for example for example in the deflection, and the ball run is improved and simplified overall. This can be achieved in that the deflection only leads to a transfer of balls of one section of the groove track to an adjacent section of the groove track, that is to say, over a flank between the adjacent groove tracks, thus enabling the distance to be bridged to be minimized. It is thus also possible to achieve a smaller outer diameter of the nut overall in comparison to solutions in which only a return from one end of the tube to the other is guided through the wall of the nut, and a complete tube has to be formed within the wall of the nut.

Instead of a single long ball return from one end of the tube to the other end of the tube, a deflection which makes it possible to transfer balls of one section of the groove track to an adjacent section of the groove track offers a better distribution of force in the event of an axial force occurring. The deflection may take place i for example during a rotation of the spindle about a spindle axis A. A deflection of this kind can be produced and integrated in the ball screw drive in a comparatively simple manner. In the case of such an embodiment of a ball return of the actuator, the balls can be guided around the spindle along the groove track approximately once, accordingly through approximately 360°, and returned again by means of the deflection into the adjacent groove track or the preceding thread. Embodiments with multiple deflections are also possible.

When an actuator is used in a clamping module for an electromechanical brake device of a motor vehicle during operation, i.e. during the application of the wheel brake, the axial forces that occur can lead to deformations of the receiving housing.

If the housing receiving the actuator or the clamping module is embodied, for example, as a caliper housing of floating shape, which is a common embodiment for disk brakes, the caliper housing can bend open when it is tensioned or spread apart by the clamping module. Therefore, depending on the magnitude of the application force applied by the clamping module, the resulting force component can no longer act on the actuator exactly parallel to the spindle axis or exactly in the axial direction.

As a consequence, the center of action of this axial force or the resulting force component can shift, in particular in the direction of the bridge of the caliper housing. In the case of a caliper housing of a disk brake, the bridge refers to that part which connects a part that supports the actuator to a part situated opposite the brake disk. In modern caliper housings, several bridges can also be provided, which can result in weight savings while gaining stability. An opening for receiving the brake disk is then typically provided opposite the bridge.

In the case of such a resulting force component displaced radially in the direction of the bridge, a non-uniform distribution of force over the balls in the groove tracks can occur. For example, those balls which run in such a manner as to point toward the bridge on sections of the grooved track can be acted upon by a greater force than on those balls which run on sections which are opposite or further spaced apart from the bridge. It must be noted here that deflections, for example, cannot absorb such forces. On the contrary, it may be the case that the ball return in deflections in sections or regions which are exposed to stronger resulting forces as a result of the application force leads to higher friction and thus takes place overall less favorably than in the case of deflections arranged in regions to which less resulting forces are applied. This may be caused by deformations or distortion of the housing during operation of the actuator. Non-uniform friction in turn can lead to non-uniform operating behavior of the actuator, which is considered to be unfavorable.

According to the embodiments, provision can therefore be made for the at least one deflection to be arranged in such a way that the resulting force components acting on the at least one deflection when an application force is applied are as small as possible. This can be illustrated for example with regard to a circular line L of a circle S which results from a section perpendicular to the spindle axis A of the actuator, if this actuator is mounted in a clamping module. The circle S may have a radius which may for example coincide with the center line of the tube for the balls.

Proceeding from the spindle axis A, the clamping module may have a direction facing the one or more bridges and an opposite direction, which accordingly points towards the opening for receiving the brake disk. In the installed state of the clamping module on a vehicle wheel, this second direction can then point toward the vehicle axle.

Furthermore, it is possible to assume a central perpendicular M, which can be perpendicular to the spindle axis A of the ball screw drive and can have two intersection points with the hypothetical circle. A first circular arc can then be defined as that part of the circular line of the circle which symmetrically adjoins on both sides the intersection point of the circle S with the central perpendicular M, said intersection point pointing toward the vehicle axis in the installed position. A second circular arc can then be defined as that part of the circular line of the circle which symmetrically adjoins on both sides the intersection point of the circle S with the central perpendicular M, said intersection point pointing toward the bridge of the housing in the installed position. The two circular arcs together may form a full circle, which can be symmetrically divided into halves by the central perpendicular M. An installed position means that an actuator is installed in a caliper housing and fixedly connected thereto.

The first circular arc may be selected such that only relatively low resulting forces are active, such that one or more deflections can be arranged in this circumferential section. In contrast, higher resulting forces can act in the circumferential portion of the second circular arc, such that this region can be kept free from deflections.

A person skilled in the art will understand that the designations “first and second circular arc” relate to the installation position of the actuator in the clamping module. Accordingly, for the manufacture of the actuator provides a first circular arc or circumferential section for the at least one deflection and to correspondingly leave a further second circular arc or circumferential section free, for example when a plurality of deflections are used. During the assembly and connection of the actuator to the clamping module, it may be then important to correspondingly orient the actuator in the housing of the clamping module such that the circular arc left free of deflections faces the bridge and the circular arc provided with deflections faces away from the bridge and thus points toward the opening for receiving the brake disk.

Accordingly, it is therefore provided that, in the installed state of the actuator, the second circular arc pointing toward the bridge, or the lateral surface adjoining in the axial direction, or the space resulting between the nut and the spindle, remains free from deflections. In this way, the deflections can be arranged in the actuator in such a way that the resulting force components acting not perpendicularly and not centrally on the clamping module can be supported in the most favorable manner and transmitted to the housing.

Thus the balls in the deflections, which cannot transmit force, can likewise be uniformly distributed or recirculated without the friction in this case becoming different as a result of the different arrangements. The deflections may accordingly be arranged in the first circular arc facing away from the bridge, or in the lateral surface adjoining this circular arc in the axial direction. In this way, it is possible to ensure very precise and low-friction ball return of the ball screw drive, even in the presence of high resulting and/or not exactly axially extending forces, such as may occur in a clamping module for a wheel brake. Here, the deflections may be designed so as to be identical with regard to their length or with regard to their inclination with respect to the spindle axis.

According to one embodiment, the second circular arc may be defined for example by an angle α to the central perpendicular M, wherein the following may apply: α≥10°, for example α≥20° and e.g. α≥30° or α≥45° or even α≥50°. Here, the specific definition of this angle α may be made according to the structural design of the actuator. In this way, it can be ensured that no deflections are provided in the critical sector of the circle in the case of force application, but rather only in that sector of the circle which is less heavily subjected to such forces.

An embodiment of may provide that the second circular arc is defined by an angle α to the central perpendicular M, wherein the following applies: α>360/number of deflections/2.

If only a single deflection is provided, according to a further embodiment, this one deflection may be arranged on the section of the circular arc facing away from the bridge. This may be a position at the lower intersection point, in the installed position, between the central perpendicular M and the circle S. In the case of a clamping module in an installed position, the lowest resulting forces are to be expected at this position, such that here, ball return with the least amount of friction is expected.

One refinement of this embodiment may provide that, as seen in the axial direction, at least two or more than two deflections are arranged lying adjacent and parallel to one another, for example at the position as described above.

In embodiments having two or more, for example three or four, deflections, they may be arranged as uniformly as possible along the available first circular arc. This may be achieved in that an angle of equal magnitude is maintained between in each case two adjacent deflections, referred to hereinafter as the angle β. According to embodiments, the following can apply to the angle β: β≥10°, for example β≥20°, e.g. β≥30°, β≥45°. An angular offset which is too small is considered to be rather unfavorable for a uniform force distribution.

According to an embodiment, the deflection for transferring the balls may take place in the region of the inner wall of the nut, for example through a corresponding cutout. In this way, the spindle can be produced without further devices for ball return.

The deflection may for example comprise a deflection piece, which permits particularly cost-effective manufacture. The deflection piece can be in the form of an insert, for example, and can be inserted into a recess in the wall of the nut.

Another embodiment may provide that the deflection is integrated into the nut. In this embodiment, the nut and the deflection may accordingly be of integral or monolithic form, and/or the deflection constitutes a part of the nut.

In a further aspect, the embodiments also relate to a clamping module, for example for an electromechanical brake device of a motor vehicle, comprising an actuator as described above and a pressure piece, which can be designed as a piston for a brake device.

The clamping module can further comprise a rotation prevention means in order to prevent rotation of the nut relative to the housing of the clamping module. In this case, the rotation prevention means can have a rotation prevention element, by means of which the nut can be held rotationally fixedly in an actuator receptacle, receiving the actuator, of the housing. According to an embodiment, the rotation prevention element may engage in an axial guide of the actuator receptacle and in this way be guided axially.

In a further aspect, the embodiments also relate to an electromechanical brake device having a clamping module as stated above.

Finally, the embodiments also relate to a motor vehicle having at least one electromechanical brake device as stated above with at least one clamping module as described above. A motor vehicle may mean a vehicle having axles, wherein at least one of these axles can comprise steerably guided wheels, and also the drive of the wheels of at least one axle can be tuned in a wheel-specific manner.

The electromechanically actuatable wheel brake of the electromechanical brake device may be designed as an electromechanical disk brake, for example as a caliper brake with a floating caliper, specifically both for front-axle and rear-axle applications in motor vehicles. It is also possible to use the clamping module with other types of wheel brakes, for example drum brakes. A combination with a parking brake is also possible.

Further details of the embodiments will emerge from the description of the illustrated exemplary embodiments and from the appended claims.

### BRIEF DESCRIPTION OF THE DRAWINGS

FIG. 1 shows a sectional view of a clamping module on according to a first embodiment,

FIG. 2 shows a view of a circle with two circular arcs,

FIG. 3 shows a cross-sectional view through a clamping module with three deflections,

FIGS. 4a, 4b each show a view of a spindle in the direction of the bridge,

FIG. 5 shows a further cross-sectional view through a clamping module with two deflections,

FIG. 6 shows a further cross-sectional view through a clamping module with four deflections,

FIG. 7 shows a sectional view of a further clamping module according to a second embodiment, and

FIG. 8 shows a sectional view of a further clamping module according to a third embodiment.

### DETAILED DESCRIPTION

In the following detailed description of the embodiments, identical reference numerals for the sake of clarity denote substantially identical parts in or on these embodiments. To better illustrate the invention, the preferred embodiments illustrated in the figures are however not always drawn to scale. For the sake of clarity, only those elements that are relevant for the design of the solution according to the invention are presented.

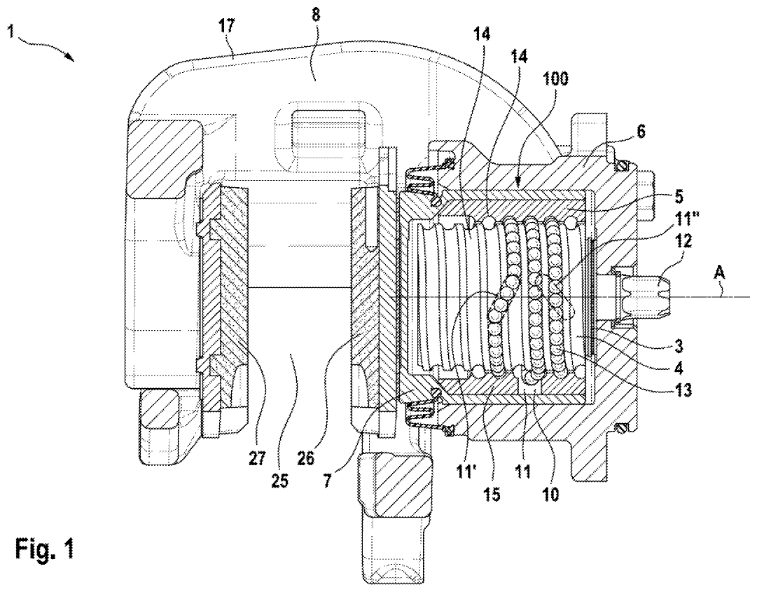

FIGS. 1, 7 and 8 show possible embodiments of a clamping module 1 according to the invention, in each case in a sectional view with in each case a mounted actuator 100. The clamping module 1 is suitable in particular for an electromechanical brake device for a motor vehicle.

The actuator 100 comprises a ball screw drive having a spindle 4 and a nut 5, wherein arranged between the spindle 4 and the nut 5 is at least one helically encircling groove track 14 which is filled with a plurality of balls 13, wherein at least one deflection 11, 11′, 11″, 11′″ is provided which permits a transfer of balls of one section of the groove track 14 to an adjacent section of the groove track 14, for example in the case of a rotation of the spindle 4 about a spindle axis A, wherein the at least one deflection 11, 11′, 11″, 11′″ is arranged along a first circular arc 23 with respect to a circular line L of a circle S which results from a section perpendicular to the spindle axis A, and wherein no deflection 11, 11′, 11″, 11′″ is arranged for example on a second circular arc 21 arranged opposite the first circular arc 23.

In the exemplary embodiments shown, the actuator 100 is installed in a clamping module 1 which is designed as an electromechanically actuatable disk brake for motor vehicles. Therefore, the actuator 100 drives a pressure piece 7 which, by means of the nut 5, can be moved axially relative to a surrounding housing 17. In this exemplary embodiment, the pressure piece is formed as a piston and is connected to a first friction element 26. FIG. 1 also shows a second friction element 27. The two friction elements 26, 27 delimit an opening 25 which can receive a brake disk (not shown) and which points toward the vehicle axle.

The clamping module 1 comprises a housing 17 which, in the exemplary embodiment, is designed as a caliper housing in the shape of a floating caliper. The ball screw drive of the actuator 100 is inserted into an actuator receptacle 6 of the housing 17.

In the exemplary embodiment, the ball screw drive of the actuator 100 comprises two helically encircling groove tracks 14, which are associated with the nut 5 and the spindle 4 and which correspond to one another. A plurality of balls 13 run in the helical tube formed in this way. In the case of a rotational movement between the spindle 4 and the nut 5, the balls 13 in this tube can move in accordance with the direction of rotation. The groove tracks 14 are led helically around the spindle 4 multiple times in multiple windings, and thus extend over more than 360°.

In the illustrated embodiment of the clamping module 1, the spindle 4 is shown not in section, thus revealing a number of balls 13 which can run in the tube formed by the groove tracks in the spindle 4 and nut 5. In this way, an axial force that arises during the application of the clamping module 1 can be readily absorbed and transmitted to the housing 17.

Visible in FIG. 1 is a deflection 11 which makes it possible for balls 13 of a section of the groove track 14 to be transferred to an adjacent section of the groove track 14. By means of the deflection 11, the balls are accordingly guided over a flank between the adjacent sections of the groove track 14. Here, the deflections are designed such that small ball chains are formed, that is to say only a few balls run in the region of the deflection. In the exemplary embodiment of FIG. 1, only two balls are arranged in the deflection. However, embodiments with, for example, 10 balls or 5 balls per deflection or four 4 balls or 3 balls in one deflection are also possible and contemplated. Overall, deflections are considered to be suitable in which fewer balls 13 run around in a deflection than balls 13 are arranged on a semicircle of the spindle 5.

Furthermore, the course of balls 13 which are transferred from one section of the groove track into the adjacent section of the groove track 14 by means of a further deflection 11′, which is not shown in the view, is shown in FIG. 1. Finally, a further deflection 11″ is also shown with dashed lines, which is intended to characterize a yet further transfer of balls 13 and which, in the view shown, is arranged on the side of the spindle facing away from the observer. In total, three deflections 11, 11′ and 11″ which are arranged axially spaced apart from one another are shown in the embodiment shown in FIG. 1. The deflections are of identical construction with regard to their length for receiving the balls.

Accordingly, provision is made not to provide any deflections 11, 11′, 11″, 11′″ in circumferential sections between the nut 5 and spindle 4, which deflections can be subjected to high resulting forces.

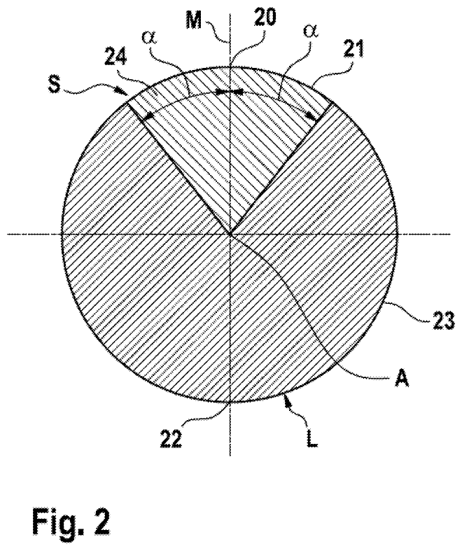

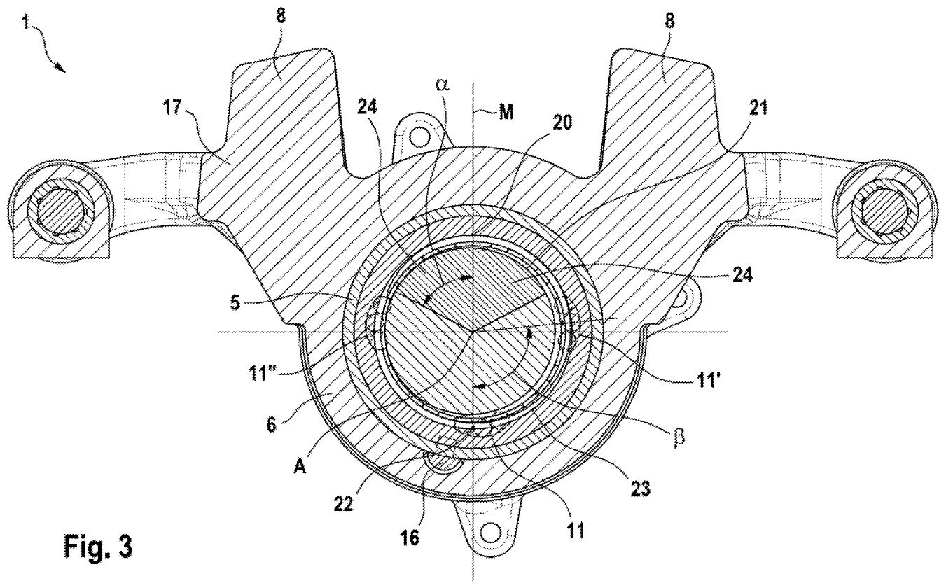

To illustrate this, FIG. 2 shows a view of a circle S with two circular arcs 21, 23, which lie on a circular line L of the circle S. The circle S illustrates a section perpendicularly through the ball screw drive. The two circular arcs 21, 23 together form a full circle. In this exemplary embodiment, the center of the circle Sis accordingly defined by the spindle axis A of the spindle 4. Also shown in FIG. 2 are the two intersection points 20, 22, which are formed by the intersection of the circle S with the central perpendicular M through the spindle axis A. In the context of the embodiments, the actuator 100 is installed in the clamping module 1 such that, in the mounted position, the point of intersection 20 points to the bridges 8, as can be clearly seen for example in FIG. 3. In the case of this embodiment, the circular arc 23 can accommodate deflections, whereas the circular arc 21 remains free from deflections.

The specific position or orientation of the deflections with respect to the clamping module is accordingly determined by the mounting or the orientation of the actuator 100 during insertion into the clamping module 1. In the exemplary embodiment, it is assumed that the orientation of the actuator 100 relative to the housing 17 of the clamping module 1 is such that the intersection point 20 points in the direction of the bridge 8, whereas the intersection point 22 is oriented in the direction of the opening 25. FIG. 3 shows in this respect a cross-sectional view through the clamping module 1 according to the embodiment from FIG. 1 with three deflections 11, 11′, 11″. The circle sector 24 defined by the circular arc 21 thus characterizes that region which can be subject to higher resulting forces when an application force is applied.

According to the embodiments, provision is therefore made for the lateral surface along the spindle 4 which adjoins the circular arc 21 in the axial direction to remain free from deflections 11, 11′, 11″, 11′″. In this way, the deflections 11, 11′, 11″, 11′″ are arranged in the actuator 100 such that the resulting force components not acting perpendicular and centered on the clamping module 1 can be supported in the most useful way. As can be seen in FIG. 3, the circle sector 24 is excluded from deflections 11, 11′, 11″, 11′″.

The second circular arc 21 is defined by an angle α to the central perpendicular M, wherein according to an embodiment, the following applies: α≥10°, for example α≥20° and e.g. α≥30° or α≥45° or even α≥50°. A correspondingly greater circular arc 21 has the effect that the clamping module 1 can absorb greater resulting forces as a result of the application force, since a greater application force can lead to more intense deformation of the housing 17. In the exemplary embodiment in FIG. 3, α is approximately 60°, thus resulting in a circle sector 24 of approximately 120°.

According to a further embodiment, it is provided that the second circular arc 21 is defined by an angle α to the central perpendicular M, wherein the following applies: α≥360/number of deflections/2.

In embodiments with two or more, for example three or four deflections 11, 11′, 11″, 11′″, according to one embodiment, provision is made for these to be arranged as uniformly as possible along a lateral surface which is defined by the first circular arc 23. This can be achieved in that an angle of equal magnitude is maintained between in each case two adjacent deflections, referred to hereinafter as angle β.

Therefore, for the angle β, in a further embodiment it follows:

β<360°/n, with n=number of deflections provided.

According to a further embodiment, provision is made for multiple deflections to be arranged at an angular offset with respect to one another along the first circular arc 23 in order to obtain a better distribution. It is therefore considered expedient if: β≥10°, preferably β≥20°, particularly preferably β≥30°, β≥45°. In the exemplary embodiment of FIG. 1, β is approximately 100°.

The clamping module 1 is formed with a rotation prevention device in order to prevent rotation of the nut 5 relative to the actuator receptacle 6. The rotation prevention comprises a rotation prevention element 16, which, in the exemplary embodiment, connects the nut 5 and the pressure piece 7 to one another in a form-fitting and rotationally fixed manner. The rotation protection element 16 furthermore engages in an axial guide of the actuator receptacle 6, and in this way is guided axially.

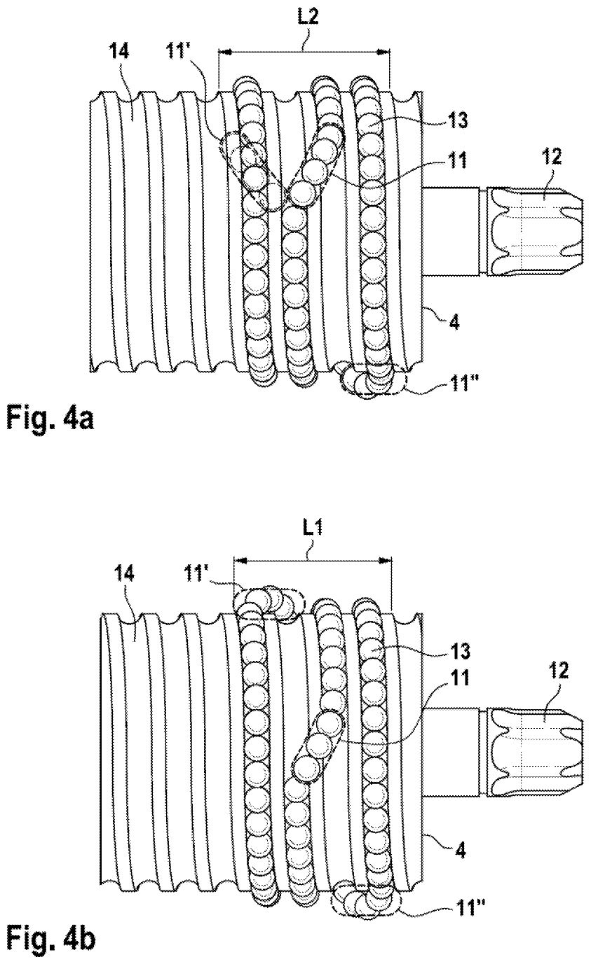

FIGS. 4a, 4b each show a view from below in the direction of the bridge on a spindle 4, wherein the deflections 11, 11′, 11″, 11′″ have different angular offsets, resulting ultimately in different installation lengths L1, L2 of the ball screw drive. Only for the sake of clarity, the deflections are only schematically indicated by the respective transfer of balls 13.

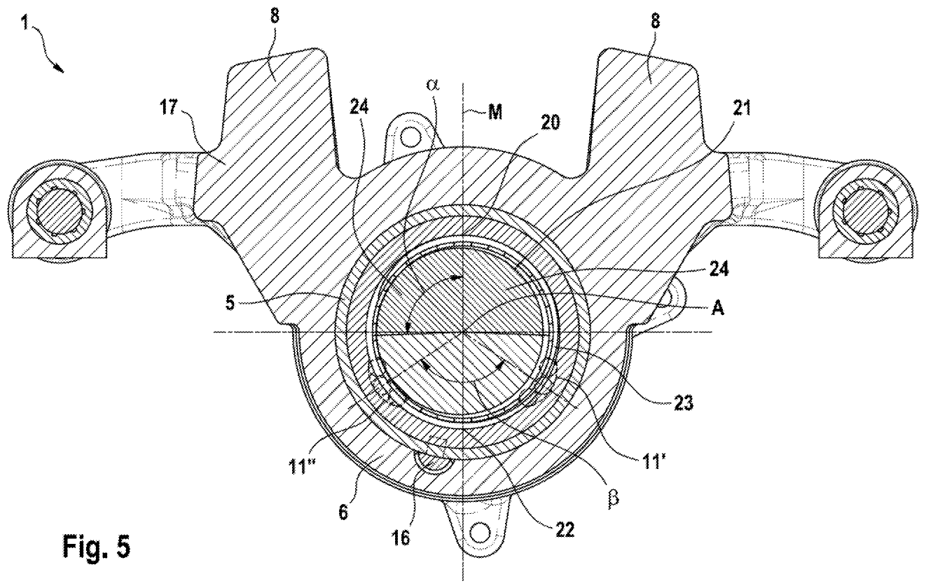

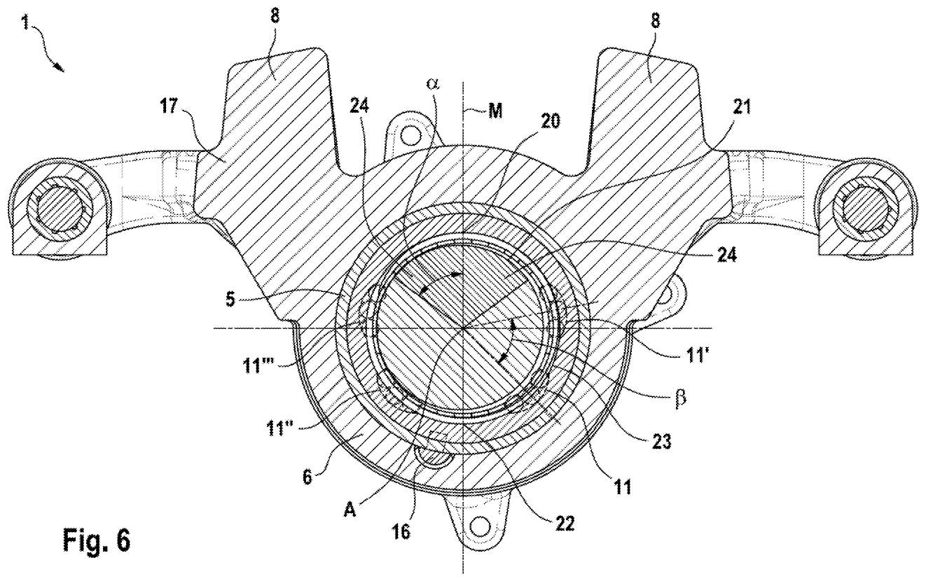

FIG. 5 shows a further cross-sectional view through a clamping module 1 according to the invention with two deflections 11′, 11″, and FIG. 6 shows a further cross-sectional view through a clamping module 1 with four deflections, 11, 11′, 11″, 11′″. In the case of the clamping module 1 shown in FIG. 5, the angle α is approximately 90°, and the angle β approximately 100°. In the exemplary embodiment of a clamping module 1 shown in FIG. 6, the angle α is approximately 45°, and the angle β approximately 70°.

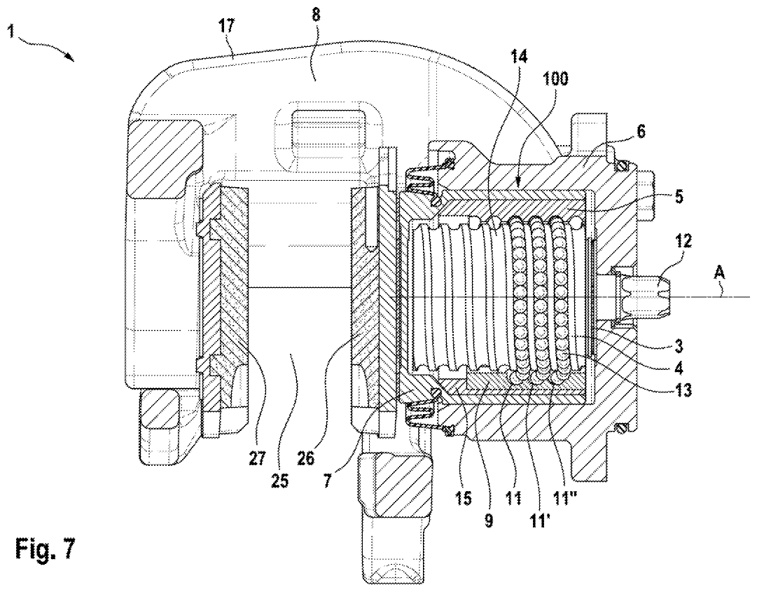

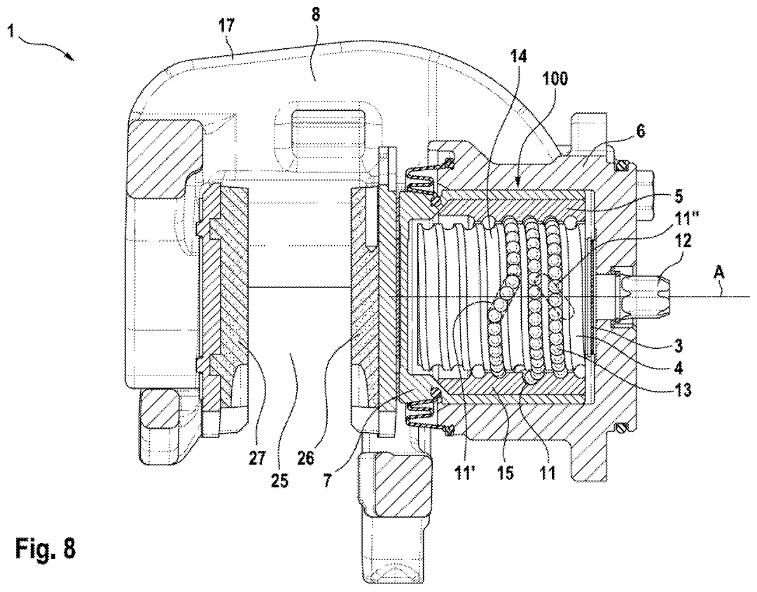

FIG. 7 shows a sectional view of a further clamping module 1 according to a second embodiment, and FIG. 8 shows a sectional view of yet a further clamping module 1 according to a third embodiment.

If only a single deflection is provided, according to a further embodiment, this one deflection may be arranged on the circular arc facing away from the bridge 8. This installation situation is drawn in the embodiment shown in FIG. 7 and affects that region that is spaced farthest away from the bridge 8. It is at this position that the lowest resulting forces are to be expected in the clamping module 1 in the installed position, such that here, ball return with the least friction is expected.

A refinement of this embodiment is shown in FIG. 7, wherein multiple axially spaced-apart deflections 11, 11′, 11″, 11′″ are provided. For economic manufacture, all of these deflections 11, 11′, 11″, 11′″ are arranged parallel and adjacent to one another at the position furthest spaced apart from the bridge 8. This allows all of the deflections 11, 11′, 11″, 11′″ to be combined together in one deflection strip 9, which is simple to produce and just as easily to be mounted in the nut 5.

In an embodiment, the deflection for transferring the balls 13 takes place in the region of the inner wall of the nut 5.

The deflection 11, 11′, 11″, 11′″ comprises, as shown in the exemplary embodiments of FIGS. 1 and 7, a deflection piece. Here, the deflection piece is in the form of an insert and is inserted into a recess in the wall 15 of the nut 5.

Another embodiment provides that the deflection 11, 11′, 11″, 11′″ is integrated in the nut 5. In this embodiment, therefore, the nut 5 and the deflection 11, 11′, 11″, 11′″ are of integral or monolithic form, and/or the deflection 11, 11′, 11″, 11′″ constitutes a part of the nut 5. FIG. 8 shows purely by way of example such an embodiment of the nut 5.

1. An actuator for a clamping module of an electromechanical brake device for a motor vehicle comprising:
a ball screw drive having a spindle and a nut;
at least one groove track defined on and helically encircling the spindle;
a plurality of balls in the at least one groove track arranged between the spindle and the nut, wherein at least one deflection is provided which permits a transfer of balls of one section of the groove track to an adjacent section of the groove track in the case of a rotation of the spindle about a spindle axis;
a first circular arc in relation to a circular line of a circle which results from a section through the ball screw drive perpendicular to the spindle axis wherein the at least one deflection is arranged along the first circular arc; and
a second circular arc arranged opposite the first circular arc wherein no deflection is arranged on the second circular arc.

2. The actuator according to claim 1, wherein the at least one groove track extends over more than 360°, preferably over a multiple of 360°.

3. The actuator according to claim 1, wherein the first circular arc symmetrically adjoins on both sides the intersection point of the circle with the central perpendicular, which in the installed position points toward the opening for receiving a brake disk.

4. The actuator according to claim 1, wherein the second circular arc symmetrically adjoins on both sides the intersection point of the circle with the central perpendicular, which in the installed position points toward the bridge.

5. The actuator according to claim 1, wherein the second circular arc is defined by an angle α to the central perpendicular, wherein the following applies: α≥10°.

6. The actuator according to claim 1, wherein the second circular arc is defined by an angle α to the central perpendicular, wherein the following applies: α>360/number of deflections/2.

7. The actuator according to claim 1, wherein at least one deflection is arranged on the first circular arc at the lower intersection point between the central perpendicular and the circle, in the installed position.

8. The actuator according to claim 1, wherein, as seen in the axial direction, at least two deflections are arranged lying adjacent and parallel to one another.

9. The actuator according to claim 1, wherein multiple deflections are combined in a deflection strip.

10. The actuator according to claim 1, wherein at least two deflections are arranged along the first circular arc, wherein an angle β of identical size is formed between two respective adjacent deflections.

11. The actuator according to claim 1, wherein an angle β is formed between at least two deflections, wherein the following applies: β≥10°.

12. The actuator according to claim 1, wherein the deflection for transferring the balls takes place in the region of the inner wall of the nut through a corresponding cutout.

13. The actuator according to claim 1, wherein a deflection comprises a deflection piece which is formed as an insert and which is inserted into the wall of the nut.

14. The actuator according to claim 1, wherein the deflection piece is designed as an insert which is arranged in or inserted into the wall of the nut.

15. The actuator according to claim 1, wherein the deflection is integrated into the nut such that the nut and the deflection are of integral or monolithic form, and/or in that the deflection constitutes a part of the nut.

16. A clamping module for an electromechanical brake device of a motor vehicle, comprising:
an actuator comprising:
a ball screw drive having a spindle and a nut;
at least one groove track defined on and helically encircling the spindle;
a plurality of balls in the at least one groove track arranged between the spindle and the nut, wherein at least one deflection is provided which permits a transfer of balls of one section of the groove track to an adjacent section of the groove track in the case of a rotation of the spindle about a spindle axis;
a first circular arc in relation to a circular line of a circle which results from a section through the ball screw drive perpendicular to the spindle axis
wherein the at least one deflection is arranged along the first circular arc; and
a second circular arc arranged opposite the first circular arc wherein no deflection is arranged on the second circular arc;
a pressure piece; and
a housing, wherein the housing is a caliper housing of a disk brake.

17. The clamping module according to claim 16, wherein a rotation prevention prevents rotation of the nut relative to an actuator receptacle receiving the clamping module, and the rotation prevention comprising:
a rotation prevention element which connects the nut and the pressure piece rotationally fixed to one another in a form-fitting manner, and an axial guide of the housing, wherein the rotation protection element engages in the axial guide.

18. An electromechanical brake device comprising:
a clamping module comprising;
a pressure piece;
a housing, wherein the housing is a caliper housing of a disk brake; and
an actuator comprising:
an actuator a ball screw drive having a spindle and a nut;
at least one groove track defined on and helically encircling the spindle;
a plurality of balls in the at least one groove track arranged between the spindle and the nut, wherein at least one deflection is provided which permits a transfer of balls of one section of the groove track to an adjacent section of the groove track in the case of a rotation of the spindle about a spindle axis;
a first circular arc in relation to a circular line of a circle which results from a section through the ball screw drive perpendicular to the spindle axis;
wherein the at least one deflection is arranged along the first circular arc; and
a second circular arc arranged opposite the first circular arc wherein no deflection is arranged on the second circular arc.

19. The electromechanical brake device of claim 18, wherein the electromechanical brake device is at least one electromechanical brake device in motor vehicle.
